(19) United States
(12) Patent Application Publication
(10) Pub. No.: US 2025/0231156 A1
(43) Pub. Date: Jul. 17, 2025

(54) ANALYSIS OF HIGH PURITY ALKYL TIN COMPOUNDS

(71) Applicant: Gelest, Inc., Morrisville, PA (US)

(72) Inventors: Li YANG, Belle Mead, NJ (US); John Michael COLLINS, Moorestown, NJ (US)

(21) Appl. No.: 19/003,622

(22) Filed: Dec. 27, 2024

Related U.S. Application Data
(60) Provisional application No. 63/619,796, filed on Jan. 11, 2024.

(51) Int. Cl. G01N 30/88; G01N 30/02

(52) U.S. Cl. CPC G01N 30/88; G01N 2030/025; G01N 2030/884

(57) ABSTRACT

A method for determining the purity of a sample comprising a monoalkyl tin triamide compound and optionally dialkyl tin diamide, tetraalkyl tin, and tetrakis(dialkylamido)tin compounds using gas chromatography is provided. The total content of dialkyl tin diamide, tetraalkyl tin, and tetrakis(dialkylamido)tin compounds detectable by the method may be less than about 40 ppm.

### CROSS-REFERENCE TO RELATED APPLICATION

This application claims priority to U.S. provisional application No. 63/619,796, filed Jan. 11, 2024, the disclosure of which is herein incorporated by reference in its entirety.

### BACKGROUND OF THE INVENTION

As semiconductor fabrication continues to advance, feature sizes continue to shrink, driving the need for new processing methods. Certain organotin compounds have been shown to be useful in the deposition of tin oxide hydroxide coatings in applications such as extreme ultraviolet (EUV) lithography techniques. For example, alkyl tin compounds provide radiation sensitive Sn—C bonds that can be used to pattern structures lithographically.

Materials used in microelectronic fabrication are required to be extremely pure with tight limits placed on organic contamination (e.g., reaction by-products), metallic contamination, and particulate contamination. Purity requirements are stringent in general, and particularly for lithography applications because the chemical is in contact with the semiconductor substrates and the organometallic impurities in compounds such as diisopropylbis(dimethylamino)tin, (iPr)₂Sn(NMe2)₂, can affect the properties of the resultant film. Exact targets for purities are determined by a variety of factors, including performance metrics, but typical minimum purity targets are 3N+. Residual metals present in the chemicals can be deposited onto the semiconductor substrate and degrade the electrical performance of the device being fabricated. Typical specifications for metals are less than 10 ppb for individual metals and total metal not to exceed ˜100 ppb.

The processing and performance of semiconductor materials may also be sensitive to dialkyl tin contaminants. Dialkyl tin impurities such as R₂Sn(NMe₂)₂, where R is an alkyl group, are the source of off-gassing after vapor phase deposition or spin-on coating processes due to the oxostannate cluster films being less dense when the film contains dialkyl groups. To produce microelectronic products using EUV lithography, proper control of dialkyl tin contaminants is required. The high purity required from the mono-alkyl tin precursor manufacturing process becomes a challenge.

Currently, the main approach for assaying the purity of monoalkyl tin amides employs ¹¹⁹Sn NMR spectroscopy. ¹¹⁹Sn NMR spectroscopy is ideally suited to the quantitative analysis of monoalkyl tin compounds due to its high sensitivity to small structural changes, large spectral range of 6500 ppm, and ease of sample preparation (see Davies et al., Eds.; Tin Chemistry: Fundamentals, Frontiers, and Applications; Wiley (2008)). This allows for easy identification and quantification of monoalkyl tin compounds and their impurities because ¹¹⁹Sn resonances are highly resolved. However, ¹¹⁹Sn NMR suffers from reduced sensitivity compared to other analytical methods such as GC, HPLC, or ¹H NMR. To improve sensitivity, monoalkyl tin compounds are typically analyzed without dilution, and many spectral acquisitions (2000+) are acquired to measure low levels of impurities (<0.1%). Due to the large number of spectral acquisitions required, analysis by ¹¹⁹Sn NMR can take several hours to acquire one spectrum with sufficient sensitivity to measure low levels of impurities.

Gas chromatography (GC) and high-performance liquid chromatography (HPLC) are two commonly used techniques for assaying the purity of compounds due to their low cost, high sensitivity, large dynamic range, and broad applicability to many classes of compounds. Direct analysis of alkyl tin amides by GC and/or HPLC, however, is difficult due to the extreme sensitivity of the tin-nitrogen bond to water and the low vapor pressure of these compounds. Direct analysis by reverse-phase HPLC is also challenging because alkyl tin amides will react with most typically employed mobile phases. Normal phase HPLC has the potential for the direct analysis of alkyl tin amides since typically used mobile phases t are not reactive towards the tin-nitrogen bond. Stationary phase selection, however, is limited because silica stationary phases, which are the most employed stationary phase in normal phase HPLC, will react with alkyl tin amides. Normal phase HPLC also suffers from reproducibility issues since trace amounts of water in the mobile phases can contribute to significant shifts in retention times and sensitivity factors.

Direct analysis by GC has different challenges and difficulties relative to HPLC. For example, consumables such as inlet liners and GC columns used for the analysis of alkyl tin amides must be highly inert, since any free silanols can react, leading to poor chromatography results. GC also has the added issue that due to the low vapor pressures of these compounds, they tend to decompose thermally in the inlet of the GC since their decomposition temperatures are often close to or lower than their boiling points.

Speciation analysis of trace organotin compounds has been an active field of research for several years due to the impact of organotin compounds on the environment (see, for example, Cole et al., “Trends in the analysis and monitoring of organotins in the aquatic environment,” Trends in Environmental Analytical Chemistry (2015)). For example, tributyltin was often used as a marine antifouling agent until it was discovered to be problematic to aquatic life at concentrations lower than 1 ng/L. GC and HPLC are the two techniques that are often used for the speciation of organotin compounds. These techniques, when paired with detectors such as MS, FPD, FAAS, or ICP-MS, can identify and detect organotin compounds at the sub-ppb level due to their high sensitivity and specificity towards Sn. These detectors, while sensitive, are rather expensive, and not readily available to most laboratories.

Speciation analysis by HPLC has the benefits that it can directly detect these alkyltin compounds with short analysis times. GC has the advantage that it is often more sensitive than HPLC due to its ability to generate sharper peaks and its ability to separate a greater number of compounds in one analysis (Wahlen, A Comparison of GC-ICP-MS and HPLC-ICP-MS for the Analysis of Organotin Compounds, Agilent Application Note (2002)). However, speciation analysis by GC often requires that samples are alkylated to make them sufficiently volatile for analysis. Sodium tetraethylborate is the most often used alkylating reagent since it can be used under aqueous conditions, making analysis of environmental samples easier. Derivatization by Grignard reagent is also employed, however, but often requires additional analytical steps to ensure samples are derivatized.

While trace analysis of organotin compounds by GC is common, no such methods have been reported for assaying the purity of such compounds using GC. A method that can be used to assay monoalkyl tin amides that is faster and more sensitive than NMR would be highly attractive for ensuring the quality of these compounds for use in the microelectronics industry.

### SUMMARY OF THE INVENTION

A method for determining the purity of a sample comprising a monoalkyl tin triamide compound having formula (1) and optionally at least one impurity selected from a dialkyl tin diamide compound having formula (2), a tetraalkyl tin compound having formula (3), and a tetrakis(dialkylamido)tin compound having formula (4):

RSn(NR′₂)₃ (1)

R₂Sn(NR′₂)₂ (2)

R₄Sn (3)

Sn(NR′₂)₄ (4)

wherein R is a primary, secondary, or tertiary, linear, branched, or cyclic alkyl group having about 1 to 10 carbon atoms and R′ is an alkyl group having about 1 to about 5 carbon atoms; the method comprising:
(a) reacting the sample with a solution of an alkylating agent comprising an alkyl group R″ to form a solution comprising a mixed tetraalkyl tin compound having formula (5) and optionally at least one compound selected from the tetraalkyl tin compound having formula (3), a mixed tetraalkyl tin compound having formula (6), and a tetraalkyl tin compound having formula (7):

RR″₃Sn (5)

R₂R″₂Sn (6)

R″₄Sn (7)

wherein R″ is a primary, secondary, or tertiary alkyl group having about 1 to 10 carbon atoms which is different from R, and
(b) employing gas chromatography to determine the relative amounts of compounds having formulas (3), (5), (6), and (7) in the solution and thereby determine the relative amounts of impurities having formulas (2), (3), and (4) in the sample. The method steps will be described in more detail below.

Advantageous refinements of the invention, which can be implemented alone or in combination, are specified in the dependent claims.

In summary, the following embodiments are proposed as particularly preferred in the scope of the present invention:

Embodiment 1: A method for determining the purity of a sample comprising a monoalkyl tin triamide compound having formula (1) and optionally at least one impurity selected from a dialkyl tin diamide compound having formula (2), a tetraalkyltin compound having formula (3), and a tetrakis(dialkylamido)tin compound having formula (4):

RSn(NR′₂)₃ (1)

R₂Sn(NR′₂)₂ (2)

R₄Sn (3)

Sn(NR′₂)₄ (4)
wherein R is a primary, secondary, or tertiary, linear, branched, or cyclic alkyl group having about 1 to 10 carbon atoms and R′ is an alkyl group having about 1 to about 5 carbon atoms; the method comprising:
(a) reacting the sample with a solution of an alkylating agent comprising an alkyl group R″ to form a solution comprising a mixed tetraalkyl tin compound having formula (5) and optionally at least one compound selected from the tetraalkyl tin compound having formula (3), a mixed tetraalkyl tin compound having formula (6), and a tetraalkyl tin compound having formula (7):

RR″₃Sn (5)

R₂R″₂Sn (6)

R″₄Sn (7)
wherein R″ is a primary, secondary, or tertiary, linear, branched, or cyclic, alkyl group having about 1 to 10 carbon atoms which is different from R, and
(b) employing gas chromatography to determine relative amounts of compounds having formulas (3), (5), (6), and (7) in the solution and thereby determine relative amounts of impurities having formulas (2), (3), and (4) in the sample.

Embodiment 2: The method according to Embodiment 1, wherein a total content of dialkyl tin diamide compounds having formula (2), tetraalkyl tin compounds having formula (3), and tetrakis(dialkylamido)tin compounds having formula (4) in the sample is less than about 500 ppm.

Embodiment 3: The method according to Embodiment 2, wherein a total content of dialkyl tin diamide compounds having formula (2), tetraalkyl tin compounds having formula (3), and tetrakis(dialkylamido)tin compounds having formula (4) in the sample is less than about 200 ppm.

Embodiment 4: The method according to Embodiment 3, wherein a total content of dialkyl tin diamide compounds having formula (2), tetraalkyl tin compounds having formula (3), and tetrakis(dialkylamido)tin compounds having formula (4) in the sample is less than about 100 ppm.

Embodiment 5: The method according to Embodiment 4, wherein a total content of dialkyl tin diamide compounds having formula (2), tetraalkyl tin compounds having formula (3), and tetrakis(dialkylamido)tin compounds having formula (4) in the sample is less than about 50 ppm.

Embodiment 6: The method according to Embodiment 1, wherein the sample is dissolved in a solvent to form a solution, and wherein the solution further comprises an internal standard.

Embodiment 7: The method according to Embodiment 1, wherein the alkylating agent is a Grignard reagent or alkyl lithium reagent comprising an alkyl group R″.

Embodiment 8: The method according to Embodiment 7, wherein the alkylating agent is R″MgBr or R″Li.

Embodiment 9: The method according to Embodiment 1, wherein the compound having formula (1) is isopropyl tris(dimethylamino) tin.

### DETAILED DESCRIPTION OF THE INVENTION

Aspects of the disclosure relate to a method for determining the purity of a sample comprising a monoalkyl tin triamide compound having formula (1) and optionally at least one impurity selected from a dialkyl tin diamide compound having formula (2), a tetraalkyl tin compound having formula (3), and a tetrakis(dialkylamido)tin compound having formula (4):

RSn(NR′₂)₃ (1)

R₂Sn(NR′₂)₂ (2)

R₄Sn (3)

Sn(NR′₂)₄ (4)

In formulas (1), (2), (3), and (4), R is a primary, secondary, or tertiary, linear, branched, or cyclic alkyl group having about 1 to 10 carbon atoms and R′ is an alkyl group having about 1 to about 5 carbon atoms. More preferably, R has 1 to about 6 carbon atoms, most preferably about 3 to about 5 carbons, such as, without limitation, primary alkyl groups including methyl, ethyl, n-propyl, n-butyl; secondary alkyl groups including isopropyl, isobutyl, sec-butyl, isopentyl, sec-pentyl, cyclohexyl, cyclopentyl, cyclobutyl, and cyclopropyl; and tertiary alkyl groups including t-butyl, t-amyl, etc.; R is preferably isopropyl or cyclopentyl. R′ is preferably methyl, ethyl, n-propyl, n-butyl, n-pentyl, and is most preferably methyl or ethyl.

The method involves:
(a) reacting the sample with a solution of an alkylating agent comprising an alkyl group R″ to form a solution comprising a mixed tetraalkyl tin compound having formula (5) and optionally at least one compound selected from the tetraalkyl tin compound having formula (3), a mixed tetraalkyl tin compound having formula (6), and a tetraalkyl tin compound having formula (7):

RR″₃Sn (5)

R₂R″₂Sn (6)

R″₄Sn (7)

wherein R″ is a primary, secondary, or tertiary, linear, branched, or cyclic, alkyl group having about 1 to 10 carbon atoms which is different from R, preferably about 2 to about 5 carbon atoms, such as the presently preferred ethyl and pentyl; and
(b) employing gas chromatography to determine the relative amounts of compounds having formulas (3), (5), (6), and (7) in the solution and thereby determine the relative amounts of impurities having formulas (2), (3), and (4) in the sample. The method steps will be described in more detail below.

Using the method described herein, it is possible to detect and quantify dialkyl tin diamide compounds having formula (2), tetraalkyl tin compounds having formula (3), and tetrakis(dialkylamido)tin compounds having formula (4) at an impurity level (of each compound separately) as low as about 500 ppm, as low as about 200 ppm, as low as about 100 ppm, as low as about 50 ppm, as low as about 40 ppm, or even lower, depending on the specific alkyl R″ group. The minimum detection limit correlates with the specific R″ group because more C—H bonds in the R″ group will increase sensitivity.

Unless otherwise stated, any numerical value is to be understood as being modified in all instances by the term “about.” Thus, a numerical value typically includes ±10% of the recited value. For example, the recitation of a temperature such as “10° C.” or “about 10° C.” includes 9° C. and 11° C. and all temperatures therebetween.

All numerical ranges expressed in this disclosure expressly encompass all possible subranges, all individual numerical values within that range, including integers within such ranges and fractions and decimal amounts of the values unless the context clearly indicates otherwise. Accordingly, the impurity levels of the compounds having formulas (2), (3), and (4) are in some embodiments each independently less than about 40 ppm, less than about 30 ppm, less than about 20 ppm, less than about 10 ppm, or even lower. Further, an alkyl group having 1 to about 4 carbon atoms may be understood to include methyl, ethyl, propyl, isopropyl, n-butyl, sec-butyl, t-butyl, cyclopropyl, and cyclobutyl even if all possible functional groups are not specifically listed.

In preferred embodiments, a total content of dialkyl tin diamide compounds having formula (2), tetraalkyl tin compounds having formula (3), and tetrakis(dialkylamido)tin compounds having formula (4) in the sample is less than about 500 ppm, less than about 200 ppm, less than about 100 ppm, less than about 50 ppm, or even lower.

In a preferred embodiment, the sample to be analyzed is dissolved in a suitable solvent such as, but not limited to, THF, to form a solution having a desired concentration, such as, but not limited to about 8 to about 12% w/v, such as about 10% w/v. An internal standard is preferably added to the solution. Appropriate internal standards for GC analysis are well known in the art and include, for example a tetraalkyl tin compound containing four identical alkyl groups which are different from R and R″ would be most preferred. Ideally, the standard is a tetraalkyl tin compound which can be chromatographically separated from the sample and all impurities. For example, if R is isopropyl and R″ is ethyl, tetrabutyltin would a suitable internal standard. The standard may be added in an amount of about 500 ppm or in an amount which is understood to be appropriate for such an internal standard for GC analysis.

Subsequently, the solution containing the sample is reacted with an alkylating agent in solution, such as a Grignard reagent or alkyl lithium reagent comprising an alkyl group R″ (R″MgBr or R″Li) to form a solution containing a mixed tetraalkyl tin compound RR″₃Sn having formula (5) from reaction of the alkylating agent with the monoalkyl tin triamide RSn(NR′₂)₃ having formula (1). Further, reaction of any dialkyl tin diamide impurity having formula (2) with the alkylating agent will lead to the formation of mixed tetraalkyl tin compound R₂R″₂Sn having formula (6) and reaction of any tetrakis(dialkylamido)tin compounds having formula (4) with the alkylating agent will lead to the formation of a tetraalkyl tin compound having formula (7) as shown:

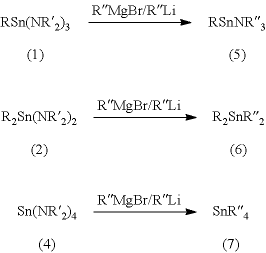

In the alkylating agent, R″ is a primary, secondary, or tertiary alkyl group having about 1 to 10 carbon atoms which is different from R. Preferably, R″ is ethyl or pentyl, so that preferred alkylating agents include ethyl Grigard, ethyl lithium, pentyl Grignard, and pentyl lithium compounds. In a preferred embodiment, the alkylating agent is added dropwise at a temperature of, for example, about 0° C. to about 25° C., and then stirred for a sufficient time to ensure complete reaction and conversion of the dialkylamido (NR′₂) groups to R″ alkyl groups, such as for about ten minutes.

The resulting solution now contains a mixed tetraalkyl tin compound having formula (5), and further optionally contains the tetraalkyltin compound having formula (3) if it was present as an impurity in the original sample, optionally contains a mixed tetraalkyl tin compound having formula (6) if there was a dialkyl tin diamide impurity having formula (2) in the sample, and optionally contains a tetraalkyl tin compound having formula (7) if there was a tetrakis(dialkylamido)tin compound having formula (4) in the original sample.

Following the reaction, the reaction mixture is treated in known ways to isolate the tin compounds which are present. For example, the excess of alkylating agent is removed by washing, such as by washing with an aqueous solution of sulfuric or acetic acid, then the organic layer is extracted and dried, such as over sodium sulfate.

Finally, a small aliquot of the organic layer is injected into a gas chromatograph equipped with a flame-ionization detector that has been calibrated for the monoalkyl tin triamide compound having formula (2) and possible impurities having formulas (3), (4), and (5), providing for quantification of the purity of the sample and the level of impurities therein using calibration data for the instrument. In other words, determination of the relative amounts of compounds (3), (5), (6), and (7), which are easily separable by GC in the solution, leads to the determination of the relative amounts of compounds (1), (2), (3), and (4) in the original sample and therefore a determination of the levels of impurities present in the original sample.

The invention will now be described in connection with the following non-limiting Example.

### Example 1: Conversion of Isopropyl Tris(dimethylamino) Tin to Triethyl Isopropyl Tin

In a glovebox, 1 mL of isopropyl tris(dimethylamino) tin and 30 ml of anhydrous ether were added to a 100 mL flask. The mixture was cooled to 0° C. then 3.01 eq of ethylmagnesium chloride (2M) was added. The mixture was warmed to room temperature and stirred for additional two hours before water work up. After extraction, the organic layer was collected and used directly as a GC sample.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for determining the purity of a sample comprising a monoalkyl tin triamide compound having formula (1) and optionally at least one impurity selected from a dialkyl tin diamide compound having formula (2), a tetraalkyltin compound having formula (3), and a tetrakis(dialkylamido)tin compound having formula (4):
RSn(NR′₂)₃ (1)
R₂Sn(NR′₂)₂ (2)
R₄Sn (3)
Sn(NR′₂)₄ (4)
wherein R is a primary, secondary, or tertiary, linear, branched, or cyclic alkyl group having about 1 to 10 carbon atoms and R′ is an alkyl group having about 1 to about 5 carbon atoms; the method comprising:
(a) reacting the sample with a solution of an alkylating agent comprising an alkyl group R″ to form a solution comprising a mixed tetraalkyl tin compound having formula (5) and optionally at least one compound selected from the tetraalkyl tin compound having formula (3), a mixed tetraalkyl tin compound having formula (6), and a tetraalkyl tin compound having formula (7):
RR″₃Sn (5)
R₂R″₂Sn (6)
R″₄Sn (7)
wherein R″ is a primary, secondary, or tertiary, linear, branched, or cyclic, alkyl group having about 1 to 10 carbon atoms which is different from R, and
(b) employing gas chromatography to determine relative amounts of compounds having formulas (3), (5), (6), and (7) in the solution and thereby determine relative amounts of impurities having formulas (2), (3), and (4) in the sample.

2. The method according to claim 1, wherein a total content of dialkyl tin diamide compounds having formula (2), tetraalkyl tin compounds having formula (3), and tetrakis(dialkylamido)tin compounds having formula (4) in the sample is less than about 500 ppm.

3. The method according to claim 2, wherein a total content of dialkyl tin diamide compounds having formula (2), tetraalkyl tin compounds having formula (3), and tetrakis(dialkylamido)tin compounds having formula (4) in the sample is less than about 200 ppm.

4. The method according to claim 3, wherein a total content of dialkyl tin diamide compounds having formula (2), tetraalkyl tin compounds having formula (3), and tetrakis(dialkylamido)tin compounds having formula (4) in the sample is less than about 100 ppm.

5. The method according to claim 4, wherein a total content of dialkyl tin diamide compounds having formula (2), tetraalkyl tin compounds having formula (3), and tetrakis(dialkylamido)tin compounds having formula (4) in the sample is less than about 50 ppm.

6. The method according to claim 1, wherein the sample is dissolved in a solvent to form a solution, and wherein the solution further comprises an internal standard.

7. The method according to claim 1, wherein the alkylating agent is a Grignard reagent or alkyl lithium reagent comprising an alkyl group R″.

8. The method according to claim 7, wherein the alkylating agent is R″MgBr or R″Li.

9. The method according to claim 1, wherein the compound having formula (1) is isopropyl tris(dimethylamino) tin.
